(19) United States
(12) Patent Application Publication
(10) Pub. No.: US 2026/0257093 A1
(43) Pub. Date: Sep. 3, 2026

(54) FIRE EXTINGUISHING SYSTEM WITH MECHANICAL ACTIVATOR

(71) Applicant: NERO ENDÜSTRI SAVUNMA SANAYI ANONIM SIRKETI, Ankara (TR)

(72) Inventor: ALICAN ÖKÇÜN, Ankara (TR)

(73) Assignee: NERO ENDÜSTRI SAVUNMA SANAYI ANONIM SIRKETI, Ankara (TR)

(21) Appl. No.: 18/713,201

(22) PCT Filed: Aug. 9, 2023
(86) PCT No.: PCT/TR2023/050793

§ 371 Date: May 24, 2024

(51) Int. Cl. A62C 37/36; A62C 5/00

(52) U.S. Cl. CPC A62C 37/04; A62C 5/006

(57) ABSTRACT

In particular, the present invention relates to a mechanical fire extinguishing system, which provides the detection of fire and/or explosion and extinguishing of flames in environments where there is a risk of fire and/or explosion, where the electrical installation/line is dangerous and maintenance/control operations are difficult, such as ammunition rooms or vehicles containing flammable/explosive materials such as batteries, which is able to operate without electrical connection and with intervention from outside the fire environment, resistant to fire/explosion temperature values.

### FIELD OF THE INVENTION

The present invention relates to a mechanical fire extinguishing system that provides the detection and extinguishment of fire and/or explosion in environments that are at risk of fire and/or explosion and are not suitable for electrical lines, and with little maintenance and control facility.

In particular, the present invention relates to a mechanical fire extinguishing system, which provides the detection of fire and/or explosion and extinguishing of flames in environments where there is a risk of fire and/or explosion, where the electrical installation/line is dangerous and maintenance/control operations are difficult, such as ammunition rooms or vehicles containing flammable/explosive materials such as batteries, which is able to operate without electrical connection and with intervention from outside the fire environment, resistant to fire/explosion temperature values.

### STATE OF THE ART

Various sensors are used to detect fire and/or explosion status in rooms or vehicles containing flammable and/or explosive materials or systems, and the fire extinguishing system is activated in accordance with the detection information of the sensors. However, it is not possible to use fire detection and extinguishing systems that only work with electrical connection in environments where ammunition rooms, battery compartments of vehicles, fuse boxes, electrical lines/installations are not suitable and/or maintenance and control operations are difficult to perform. Furthermore, there is a power outage as a result of fire or explosion occurring in the vehicle or the environment, and in this case, problems arise in the activation of the fire extinguishing system.

Sufficient pressure and flow are provided from a water distribution pipeline to which the system is connected in sprinkler systems, which are among the systems that provide fire protection and rapid extinguishing and the pressurized water that extinguishes the flames is distributed into the environment with the help of spray nozzles. The glass socket bulb used in spray fire extinguishing systems is broken when the ambient temperatures reach certain degrees in fires, opening the way for water and allowing water or gas to escape to the environment. In these systems, water leaks may occur due to the fact that the water distribution line is under the influence of constant pressure and the pump or pressure tube, which is constantly ready at the inlet end of the system, must be connected. Hermetically closed tubes provide spraying with the help of nozzles from non-pressurized lines only in case of receiving an activation signal. However, malfunctions may occur in the sensors that provide the activation signal with the effect of power cut or high temperature during the fire and/or explosion and due to the fact that the extinguishing process does not start on time, it causes dangerous situations. Likewise, negative situations such as gas leakage in the cylinders or accidental cutting of the cylinders and activation of the fire extinguishing system in pneumatically activated fire extinguishers, result in untimely use and inability to use when needed.

In a patent document numbered U.S. Pat. No. 3,802,510A, which is in the state of the art, a spray fire extinguishing system containing a temperature-controlled valve mechanism is described for automatic extinguishing of the fire. The spray valve that controls the pressurized water transmission is opened automatically and repeatedly in said system after sensing the temperature caused by the fire, and after the flames are extinguished, it is closed again with the effect of falling temperature. The actuation of the spray valve is provided by an actuation element, and the actuation element is associated with a control element. There is a material in the control element that can be stretched with the effect of temperature, and the valve can be moved in different directions with the help of this material in case the temperature increases or decreases. Said document does not mention a solution for controlling the operation of the valve and the start of the spraying process from the outside or preventing the operation of the valve from being disrupted with the effect of temperature.

As a result, especially in environments where power lines/plumbing are dangerous, maintenance and/or control operations are difficult to perform and access, there is a need to develop a mechanical fire extinguishing system that enables the detection of fire and/or explosion and extinguishing the flames, without the need for electrical connection, suitable for operation by intervention from outside the fire environment and resistant to the temperature values during fire/explosion.

### Aim of the Invention

The present invention is related to a mechanical fire extinguishing system which fulfills the abovementioned requirements, eliminates all disadvantages and brings some additional advantages.

The main aim of the inventive mechanical fire extinguishing system relates to a mechanical fire extinguishing system that provides the detection of fire and/or explosion and extinguishing the flames in environments where there is a risk of fire and/or explosion, where the electrical installation/line is dangerous and maintenance/control operations are difficult to perform.

Another aim of the present invention is to obtain a mechanical fire extinguishing system that allows operation without the need for electrical connection and with intervention from outside the fire environment.

Another aim of the present invention is to obtain a safe mechanical fire extinguishing system that is resistant to temperature values caused by fire and/or explosion and offers long-lasting use.

Another aim of the present invention is to obtain an efficient and effective mechanical fire extinguishing system that does not need an external detector or detection element, reduces the cost of renewal, maintenance and repair of the system, and does not need a pump system that is constantly ready.

In order to achieve the above objectives in their most general form, mechanical fire extinguishing system, which comprises at least one starting element, at least one extinguishing element, enables the detection of fire and/or explosion and extinguishing flames in environments where there is a risk of fire and/or explosion, electrical installation/line is dangerous and maintenance/control operations are difficult to perform, allows to increase physical strength, to work without the need for electrical connection and/or with intervention from outside the fire environment, comprises the following; at least one drive element that enables the application of a force in a first direction and initiation of operation of the system by the effect of rising heat from fire and/or explosion; at least one trigger element that provides the detonation of the drive element and helps to start the operation of the system when the user intervenes from outside the fire and/or explosion environment, at least one transfer element that provides the initial energy to be received and transmitted to the extinguishing element by applying force in the first direction.

The structural and characteristic features of the present invention will be understood clearly by the following drawings and the detailed description made with reference to these drawings and therefore the evaluation shall be made by taking these figures and the detailed description into consideration.

### FIGURES CLARIFYING THE INVENTION

In order to understand the advantages of the present invention with its structure and additional elements, it shall be evaluated with the following defined figures.

FIG. 1: is a schematic view of the inventive mechanical fire extinguishing system.

### PART REFERENCES

1. Starting element
2. Extinguishing element
3. Drive element
4. Trigger element
5. Transfer element
6. Control unit
7. Transmission element
8. Operating element
9. Activation unit
10. Sensing element

### DETAILED DESCRIPTION OF THE INVENTION

In this detailed description, the preferred embodiments of the inventive mechanical fire extinguishing system are described only for clarifying the subject matter in a manner such that no limiting effect is created.

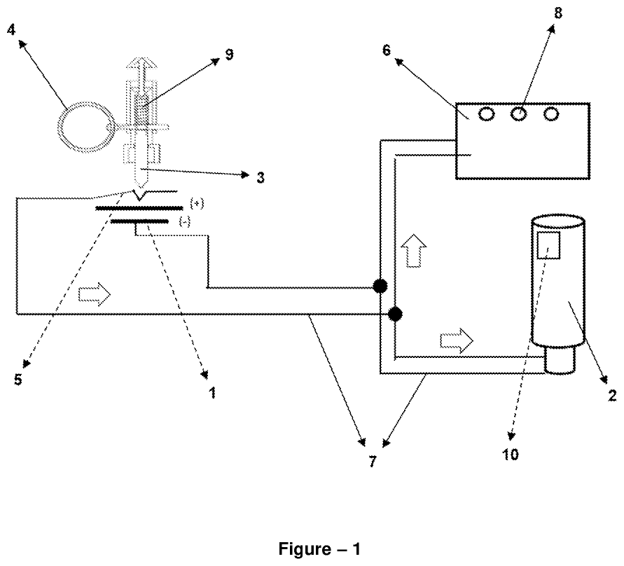

Mechanical fire extinguishing system, the example view of which is given in FIG. 1, which is developed with the present invention, comprises at least one starting element (1), preferably in the form of a battery, which provides the generation of starting energy to start the operation of the system, at least one extinguishing element (2), preferably a fire extinguisher, that provides pressurized storage of the extinguishing material that extinguishes the flames therein, enables the detection of fire and/or explosion and extinguishing flames in environments where there is a risk of fire and/or explosion, electrical installation/line is dangerous and maintenance/control operations are difficult to perform, allows to increase physical strength, to work without the need for electrical connection and/or with intervention from outside the fire environment, comprises the following; at least one drive element (3), preferably comprising an aerosol tube, positioned close to the starting element (1), enabling the application of force in the first direction and initiation of the system by bursting or breaking under the effect of fire and/or explosion rising heat; at least one trigger element (4), preferably in the form of a pin, which is in connection with the drive element (3), which allows the drive element (3) to explode or break when the user intervenes from outside the fire and/or explosion environment, and helps to start the operation of the system; extinguishing element (2), which is located on the side of the starting element (1) close to or far from the drive element (3), in order to receive the initial energy required for the operation of the system by contacting the starting element (1) with the application of force in the first direction and to initiate the spraying of the extinguishing material; preferably at least one transfer element (5) which is conductive and flexible.

In an exemplary application of the mechanical fire extinguishing system developed with the present invention, the drive element (3) is positioned close to the starting element (1). The drive element (3) explodes, causing a force to be produced in the first direction by pulling the trigger element (4) by the user or by the effect of rising heat in case of fire and/or explosion. The starting element (1) and the transfer element (5) come into contact with this force effect and it is transmitted to the extinguishing element (2) via the transfer element (5). In this way, the extinguishing process is carried out by spraying the pressurized extinguishing material in the extinguishing element (2) to the environment where fire and/or explosion occurs.

In a preferred embodiment of the invention said mechanical fire extinguishing system comprises at least one control unit (6), which is associated with said extinguishing element (2) and said transfer element (5), enables to control the spraying process of the extinguishing material inside said extinguishing element (2), to detect the energy transmission state of the said transfer element (5) and to transmit an audible and/or visual fire and/or explosion warning to the user, is preferably suitable for remote data transfer.

In another preferred embodiment of the invention, said mechanical fire extinguishing system comprises at least one transmission element (7) which is associated with said transfer element (5), said extinguishing element (2) and/or said control unit (6), is suitable for the transmission of electrical energy and/or signal on it and provides the transmission of the energy and/or electrical signal received from said starting element (1), is preferably in wire or cable structure.

In another preferred embodiment of the invention, said mechanical fire extinguishing system comprises at least one operating element (8) located on said control unit (6), which enables the operation of the system to be controlled manually, preferably in the form of a button.

In another preferred embodiment of the invention, said mechanical fire extinguishing system comprises at least one activation unit (9) which is associated with said drive element (3) and enables the force of said drive element (3) to be generated and directed in said first direction, preferably with or without pre-tensioned structure, preferably with spring or solenoid mechanism.

In another preferred embodiment of the invention, said mechanical fire extinguishing system comprises at least one sensing element (10) which is associated with said extinguishing element (2) and said control unit (6), enables the detection of the occupancy status of said extinguishing element (2) and transmitting the status information to said control unit (6), preferably in the form of sensor.

The detection of fire and/or explosion and extinguishing of flames are provided quickly, especially in environments where electrical line/installation is dangerous, maintenance and/or control operations are difficult to perform and access is difficult with the help of the mechanical fire extinguishing system developed with the present invention. In this way, an efficient, effective and functional mechanical fire extinguishing system is obtained, which does not need electrical connection, is suitable for operation by intervening outside the fire environment, and is resistant to temperature values during fire/explosion and provides long-lasting use.

1. A mechanical fire extinguishing system, which comprises at least one starting element (1) that provides the generation of starting energy to start the operation of the system, at least one extinguishing element (2), which ensures that the extinguishing material that extinguishes the flames is kept in a pressurized manner, which provides the detection of fire and/or explosion and extinguishing flames in environments where there is a risk of fire and/or explosion, electrical installation/line is dangerous and maintenance/control operations are difficult to perform, which allows to increase physical strength, to work without the need for electrical connection and/or with intervention from outside the fire environment, characterized in that, it comprises the following;
at least one drive element (3) located in close proximity to said starting element (1), enabling the application of a force in a first direction and initiation of operation of the system by exploding or breaking under the effect of fire and/or explosion rising heat;
at least one trigger element (4) in connection with said drive element (3), which enables said drive element (3) to explode or break when the user intervenes from outside the fire and/or explosion environment and helps to start the operation of the system;
at least one transfer element (5), which is located on the side of said starting element (1) that is close or far from said drive element (3), ensures that the initial energy required for the operation of the system is taken by contacting said starting element (1) by applying force in said first direction and that said extinguishing material is transmitted to said extinguishing element (2) to initiate the spraying process.

2. A mechanical fire extinguishing system according to claim 1, characterized in that, said starting element (1) is in battery structure.

3. A mechanical fire extinguishing system according to claim 1, characterized in that, said extinguishing element (2) is a fire extinguisher.

4. A mechanical fire extinguishing system according to claim 1, characterized in that, said drive element (3) comprises an aerosol tube.

5. A mechanical fire extinguishing system according to claim 1, characterized in that, said trigger element (4) is in pin structure.

6. A mechanical fire extinguishing system according to claim 1, characterized in that, said transmission element (5) is in a conductive and flexible structure.

7. A mechanical fire extinguishing system according to claim 1, characterized in that, it comprises at least one control unit (6), which is associated with said extinguishing element (2) and said transfer element (5), enables to control the spraying process of the extinguishing material inside said extinguishing element (2), to detect the energy transmission state of the said transfer element (5) and to transmit an audible and/or visual fire and/or explosion warning to the user, is preferably suitable for remote data transfer.

8. A mechanical fire extinguishing system according to any of the preceding claims, characterized in that, it comprises at least one transmission element (7) which is associated with said transfer element (5), said extinguishing element (2) and/or said control unit (6), is suitable for the transmission of electrical energy and/or signal on it and provides the transmission of the energy and/or electrical signal received from said starting element (1), is preferably in wire or cable structure.

9. A mechanical fire extinguishing system according to claim 7, characterized in that, it comprises at least one operating element (8) located on said control unit (6), which enables the operation of the system to be controlled manually, preferably in the form of a button.

10. A mechanical fire extinguishing system according to claim 1, characterized in that, it comprises at least one activation unit (9) which is associated with said drive element (3) and enables the force of said drive element (3) to be generated and directed in said first direction, preferably with or without pre-tensioned structure, preferably with spring or solenoid mechanism.

11. A mechanical fire extinguishing system according to claim 7, characterized in that, it comprises at least one sensing element (10) which is associated with said extinguishing element (2) and said control unit (6), enables the detection of the occupancy status of said extinguishing element (2) and transmitting the status information to said control unit (6), preferably in the form of sensor.
